(19) United States
(12) Patent Application Publication
(10) Pub. No.: US 2007/0240535 A1
(43) Pub. Date: Oct. 18, 2007

(54) Handlebar extension

(76) Inventor: Wendell A. Thomas, Evanston, IL (US)

Correspondence Address: CARDINAL LAW GROUP;Suite 2000, 1603 Orrington Avenue, Evanston, IL, 60201, US

(21) Appl. No.: 11/405,758

(22) Filed: Apr. 18, 2006

(51) Int. Cl. B62K 21/12

(52) U.S. Cl. 74/551.1

(57) ABSTRACT

A handlebar extension includes a handlebar connector including a compressible locking portion and a grip portion rotatably connected to the handlebar connector; wherein the compressible locking portion is inserted within an opening in the handlebar, and wherein the connector is rotated to compress the compressible locking portion within the handlebar opening.

### FIELD OF THE INVENTION

This invention relates generally to handlebars. More specifically, the invention relates to a handlebar extension for a bicycle.

### BACKGROUND OF THE INVENTION

Riding a bicycle is an inexpensive and convenient method of transportation for many people. However, holding the handlebars generally causes the rider to lean forward in the seat, potentially placing the rider in an uncomfortable position. Indeed, many racing handlebars are intended to place the rider in an aerodynamic position and minimize wind resistance.

Many casual riders, or riders with ailing backs, may prefer to maintain a less aerodynamic, and more vertical position while riding.

Therefore, it would be desirable to provide a handlebar that overcomes the aforementioned and other disadvantages.

### SUMMARY OF THE INVENTION

One aspect of the invention provides a handlebar extension includes a handlebar connector including a compressible locking portion and a grip portion rotatably connected to the handlebar connector; wherein the compressible locking portion is inserted within an opening in the handlebar, and wherein the connector is rotated to compress the compressible locking portion within the handlebar opening.

Another aspect of the invention comprises a bicycle including a handlebar extension that includes a handlebar connector including a compressible locking portion and a grip portion rotatably connected to the handlebar connector; wherein the compressible locking portion is inserted within an opening in the handlebar, and wherein the connector is rotated to compress the compressible locking portion within the handlebar opening.

Another aspect of the invention provides a handlebar extension comprising means for compressing a locking portion within an opening of a handlebar and a grip portion rotatably connected to the compression means.

The aforementioned, and other features and advantages of the invention will become further apparent from the following detailed description of the presently preferred embodiments, read in conjunction with the accompanying drawings. The detailed description and drawings, which are not to scale, are merely illustrative of the invention rather than limiting, the scope of the invention being defined by the appended claims and equivalents thereof.

### BRIEF DESCRIPTION OF THE DRAWINGS

FIG. 1 is a side view of one embodiment of a handlebar extension, in accordance with one aspect of the present invention;

FIG. 2 is a perspective view of one embodiment of a handlebar connector, in accordance with one aspect of the present invention;

FIG. 3 is a perspective view of a handlebar extension in accordance with one aspect of the invention; and

FIG. 4 is a side view of one embodiment of a bicycle, in accordance with one aspect of the present invention.

### DETAILED DESCRIPTION OF THE DRAWINGS

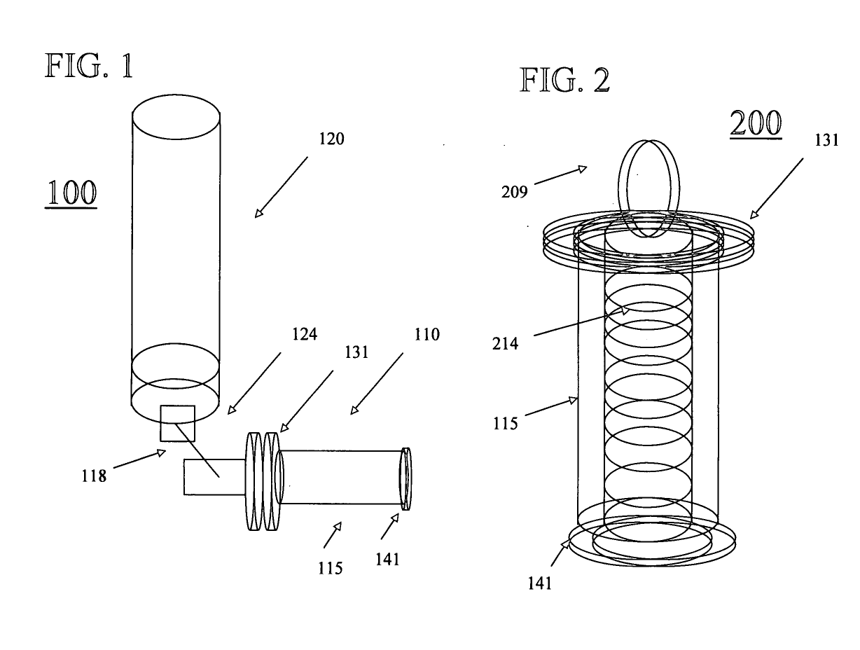

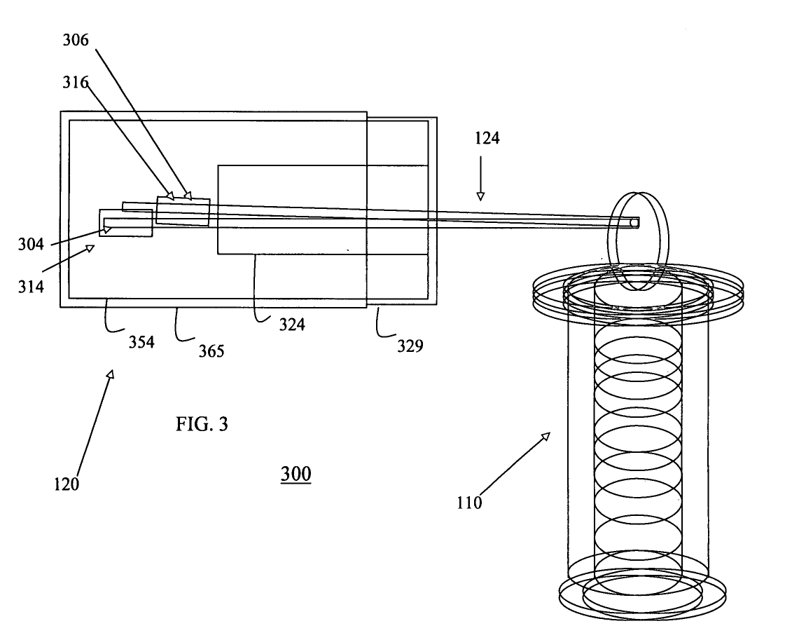

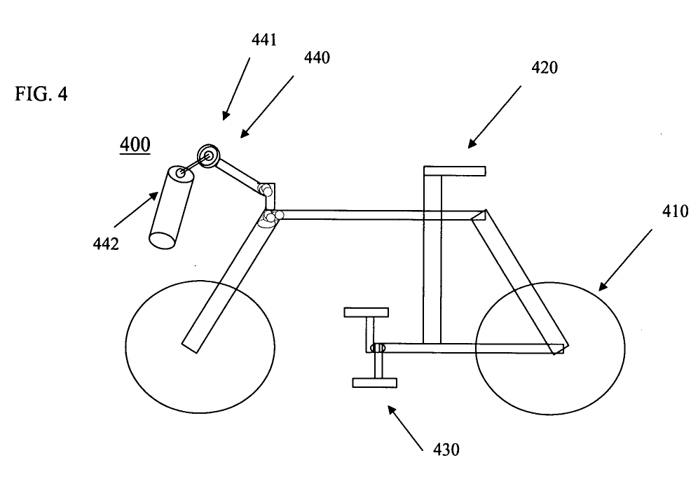

FIG. 1 illustrates a side view of a handlebar extension 100 in accordance with one aspect of the invention. Handlebar extension 100 includes a handlebar connector 110 connected to a grip portion 120.

Handlebar connector 110 includes a compressible locking portion 115 sized to be inserted within a handlebar opening. Compressible locking portion 115 expands to fill the handlebar opening so that the handlebar connector is gripped within the handlebar opening. In one embodiment, compressible locking portion 115 includes at least one cylindrical portion of a compressible material, such as rubber. For example, compressible locking portion 115 includes coaxial rubber cylinders, although a single cylinder can be used.

In one embodiment, handlebar connector 110 connects to grip portion 120 with an eye-bolt 118. Eye-bolt 118 includes a head 209 (FIG. 2) connected to a threaded shaft 214. Compressible locking portion 115 surrounds the threaded shaft 214 and is maintained between at least one washer 131 disposed near the head of the eye-bolt and a t-nut 141 opposite the head of the eye-bolt. The t-nut 141 engages with the threaded shaft 214 to translate along the threaded shaft. Rotation of the eye-bolt 209 translates the t-nut 141 along the threaded shaft 214 to compress or de-compress the compressible locking portion 115.

The handlebar connector connects to the grip portion, in one embodiment, with a length of rope 124. Length of rope 124 includes a first end 304 and a second end 306. Rope 124 can include any rope or string material. In one embodiment, rope 124 is covered with a stiffener to increase the rigidity of the rope. For example, a starter rope is used in one embodiment. In one embodiment, rope 124 includes a plurality of discrete lengths of rope. For example, two discrete lengths of rope are used in one embodiment. Use of multiple discrete lengths of rope can provide redundancy based on design choices.

A first fitting 314 attaches to first end 304, and a second fitting 316 attaches to the second end 306. The first and second fittings are forced against a block 324 that abuts a cap 329 to apply tension to the rope. In one embodiment, the first and second fittings 314, 316 are crimped to the rope 124. The tension in the rope maintains the relative positions of the handlebar connector and grip portion. The cap 329 is attached to a handle tube 354, such as via a threaded connector. Additionally, the handle tube 354 surrounds the first and second ends, as well as the block 324 and first and second fittings 314, 316. The handle tube 354 includes a padded portion 365, in one embodiment. Instead of a fitting system, other embodiments can include locking nuts, clamps or ratchets. In another embodiment, a brake controller is connected to the grip portion. In another embodiment, a brake controller is connected to the handlebar portion. In yet another embodiment, a brake controller is actuated based on movement of the grip portion relative to the handlebar portion. For example, pushing the grip portion in the direction of bicycle travel actuates the brakes in one such embodiment. Conversely, pulling the grip portion in the direction opposite bicycle travel actuates the brakes in another embodiment.

FIG. 4 illustrates one example of a bicycle 400 in accordance with one aspect of the invention. Bicycle 400 includes at least one wheel 410 (illustrated with two wheels), and at least one seat 420 (illustrated with one) with at least one pedal 430 in driving engagement with at least one wheel 410 (illustrated as one). Additionally, bicycle 400 includes a handlebar 440 comprising a handlebar connector 441 including a compressible locking portion and a grip portion 442 rotatably connected to the handlebar connector; wherein the compressible locking portion is inserted within an opening in the handlebar 440, and wherein the connector is rotated to compress the compressible locking portion within the handlebar opening. In one embodiment, the handlebar extension disclosed herein is used for the rear rider on a tandem bicycle.

In another embodiment, the handlebar connectors disclosed herein include a first tube and a second tube connected by a length of rope surrounded by a handlebar tube. For example, the first tube includes a pin inserted through the first tube substantially perpendicular to an axis running through the center of an ovoid shape defining a first end of the first tube. The rope enters the first tube on one side of the pin, and exits the first tube on an opposite side of the pin, and both sides of the rope extend through the length of the handlebar. On the opposite side of the handlebars, the second tube accepts both sides of the rope, and both sides of the rope extend through the second tube. A fitting attaches to each side of the rope on a side of the second tube opposing the handlebar. One side of rope is disposed on a first side of a pin inserted through the second tube substantially perpendicularly to an axis running through the center of an ovoid shape defining a third end of the second tube. The other side of the rope is disposed on a second side of the pin in the second tube, and the fitting is used to grip each side of the rope, and apply tension along the length of the rope by pressing against the pin.

In yet another example, the grip portion attaches to the eye-bolt of the handlebar connector with a second eye-bolt. The second eye-bolt is anchored in a cap that attaches to the grip portion, such as with a threaded connector.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A handlebar extension for a bike handlebar, comprising:
a handlebar connector including a compressible locking portion;
a grip portion rotatably connected to the handlebar connector; wherein the compressible locking portion is inserted within an opening in the handlebar, and wherein the connector is rotated to compress the compressible locking portion within the handlebar opening.

2. The handlebar extension of claim 1 wherein the compressible locking portion comprises at least one cylindrical portion of a compressible material.

3. The handlebar extension of claim 2 wherein the compressible material comprises rubber.

4. The handlebar extension of claim 1 wherein the grip portion connects to the handlebar with an eye-bolt, the eye-bolt including a head connected to a threaded shaft surrounded by the compressible locking portion, and the threaded shaft mating with a t-nut, wherein rotation of the head translates the t-nut along the threaded shaft.

5. The handlebar extension of claim 4 wherein the compressible locking portion is maintained between at least one washer disposed near the head and the t-nut.

6. The handlebar extension of claim 1 wherein the grip portion connects to the handlebar connector with a rope extending through a head of an eye-bolt.

7. The handlebar extension of claim 6 wherein the rope includes a first end and a second end, and wherein the rope is held in place with a first fitting attached to the first end and a second fitting attached to the second end.

8. The handlebar extension of claim 7 wherein the rope extends through a hole in a cap, the cap connecting to a handle tube, wherein the handle tube surrounds the first fitting and second fitting.

9. The handlebar extension of claim 1 wherein the compressible locking portion comprises at least one cylindrical portion of rubber and wherein the grip portion connects to the handlebar with an eye-bolt, the eye-bolt including a head connected to a threaded shaft surrounded by the compressible locking portion, and the threaded shaft mating with a t-nut, wherein rotation of the head translates the t-nut along the threaded shaft, and wherein the compressible locking portion is maintained between at least one washer disposed near the head and the t-nut, and wherein the grip portion connects to the handlebar connector with a rope extending through a head of an eye-bolt and wherein the rope extends through a hole in a cap, the cap connecting to a handle tube, wherein the handle tube surrounds a first fitting and a second fitting.

10. A bicycle comprising:
at least one wheel;
at least one seat;
at least one pedal in driving engagement with at least one wheel; and
a handlebar comprising a handlebar connector including a compressible locking portion and a grip portion rotatably connected to the handlebar connector; wherein the compressible locking portion is inserted within an opening in the handlebar, and wherein the connector is rotated to compress the compressible locking portion within the handlebar opening.

11. The bicycle of claim 10 wherein the compressible locking portion comprises rubber.

12. The bicycle of claim 10 wherein the grip portion connects to the handlebar with an eye-bolt, the eye-bolt including a head connected to a threaded shaft surrounded by the compressible locking portion, and the threaded shaft mating with a t-nut, wherein rotation of the head translates the t-nut along the threaded shaft.

13. The bicycle of claim 12 wherein the compressible locking portion is maintained between at least one washer disposed near the head and the t-nut.

14. The bicycle of claim 10 wherein the grip portion connects to the handlebar connector with a rope extending through a head of an eye-bolt.

15. The bicycle of claim 14 wherein the rope includes a first end and a second end, and wherein the rope is held in place with a first fitting attached to the first end and a second fitting attached to the second end.

16. The bicycle of claim 15 wherein the rope extends through a hole in a cap, the cap connecting to a handle tube, wherein the handle tube surrounds the first fitting and second fitting.

17. The bicycle of claim 10 wherein the compressible locking portion comprises at least one cylindrical portion of rubber and wherein the grip portion connects to the handlebar with an eye-bolt, the eye-bolt including a head connected to a threaded shaft surrounded by the compressible locking portion, and the threaded shaft mating with a t-nut, wherein rotation of the head translates the t-nut along the threaded shaft, and wherein the compressible locking portion is maintained between at least one washer disposed near the head and the t-nut, and wherein the grip portion connects to the handlebar connector with a rope extending through a head of an eye-bolt and wherein the rope extends through a hole in a cap, the cap connecting to a handle tube, wherein the handle tube surrounds a first fitting and a second fitting.

18. A handlebar extension comprising:
means for compressing a locking portion within an opening of a handlebar and a grip portion rotatably connected to the compression means.

19. The handlebar extension of claim 1 wherein the grip portion connects to the handlebar connector with a rope extending through a head of an eye-bolt, and wherein the rope extends through a hole in a cap mounted to a handle tube, wherein the handle tube surrounds a first fitting and a second fitting, the first fitting attached to a first end of the rope and the second fitting attached to a second end of the rope.

20. The bicycle of claim 10 wherein the grip portion connects to the handlebar connector with a rope extending through a head of an eye-bolt, and wherein the grip portion and rope extend outside the handlebar, and wherein the rope extends through a hole in a cap mounted to a handle tube, wherein the handle tube surrounds a first fitting and a second fitting, the first fitting attached to a first end of the rope and the second fitting attached to a second end of the rope.
